(19) United States
(12) Patent Application Publication
(10) Pub. No.: US 2004/0149032 A1
(43) Pub. Date: Aug. 5, 2004

(54) Liquid level sensor

(76) Inventor: Jeffrey A. Sell, West Bloomfield, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/356,074

(22) Filed: Jan. 31, 2003

(51) Int. Cl. G01F 23/00

(52) U.S. Cl. 73/304 C; 340/620

(57) ABSTRACT

A capacitive liquid level sensor provides for a reliable and inexpensive means to measure fluid height. The capacitance measured at a sensor is interpreted by a control unit, which relays information regarding the liquid level to a display unit visible to the driver of the motor vehicle. In one embodiment, the sensor consists of two parallel electrode strips of a conductive material supported along their respective lengths by a substrate of an insulated material. The strips and the exposed side of the substrate are coated with a low conductivity porous material. The strips are connected to a control unit by a pair of electrical leads. When the sensor is immersed in a liquid, the control unit measures capacitance between the two strips and calculates the actual liquid height, based on the known dielectric constant of the liquid and the gas above it.

### TECHNICAL FIELD

This invention relates generally to a liquid level sensor, and more specifically to a capacitive liquid level sensor for use in a motor vehicle application.

### BACKGROUND OF THE INVENTION

Liquid level sensors find application throughout motor vehicles, in locations such as the engine oil reservoir, windshield washer fluid reservoir, and radiator, to name just a few sites. Conventional liquid level sensors for use in motor vehicles are based on optical, ultrasound, potentiometric, and float-type systems. All of these devices perform the same functions of measuring the liquid level and relaying this information to the motor vehicle driver or to an appropriate controller on board the vehicle; however, each of these devices performs these given functions in a different manner. Of these liquid level sensor types, the potentiometric is the simplest, but it is subject to wear, decreasing its accuracy over time. The float-type device is also subject to wear over time, making it prone to the same problems associated with the potentiometric type device. The other two types of liquid level sensors are reliable but require expensive and complicated signal conditioning and amplification equipment.

It is desirable to have a liquid level sensor that will accurately and reliably measure the liquid level at any of the critical fluid areas, including, but not limited to, the areas listed above, and relay this information to the driver of the motor vehicle, while at the same time being inexpensive. Accordingly, a need exists for a reliable yet inexpensive liquid level sensor.

### SUMMARY OF THE INVENTION

A liquid level sensor is provided in accordance with the present invention. The liquid level sensor comprising an insulated substrate, a pair of spaced apart electrically conductive electrodes supported by the insulated substrate, and a layer of porous material overlying the pair of spaced apart electrically conductive electrodes.

### BRIEF DESCRIPTION OF THE DRAWINGS

The invention will be understood after review of the following description considered together with the drawings in which:

FIG. 1 schematically illustrates an application of a liquid level sensor in accordance with one embodiment of the invention;

FIGS. 2 and 3 illustrate, in plan and cross-sectional views, respectively, a liquid level sensor in accordance with one embodiment of the invention;

FIG. 4 illustrates graphically the experimental results obtained using an embodiment of the liquid level sensor;

FIGS. 5 and 6 illustrate schematically, in plan view, additional capacitive liquid level sensors in accordance with further embodiments of the invention; and

FIG. 7 illustrates schematically, in plan view, a capacitive liquid level sensor in accordance with yet another embodiment of the invention.

### DESCRIPTION OF THE PREFERRED EMBODIMENT

A capacitive liquid level sensor, in accordance with one embodiment of this invention, utilizes measurements of the capacitance of an immersed sensor to indicate liquid height. The capacitance measured at the sensor is interpreted by a control unit, which relays information regarding the liquid level to a display unit visible to the driver of the motor vehicle or to an appropriate controller on board the vehicle. Capacitive liquid level sensors, in accordance with the invention, also find use in applications other than motor vehicles. Although the various embodiments of the invention will be described herein as they apply to motor vehicle applications, such description is merely for convenience and is not intended to limit the scope or application of the invention.

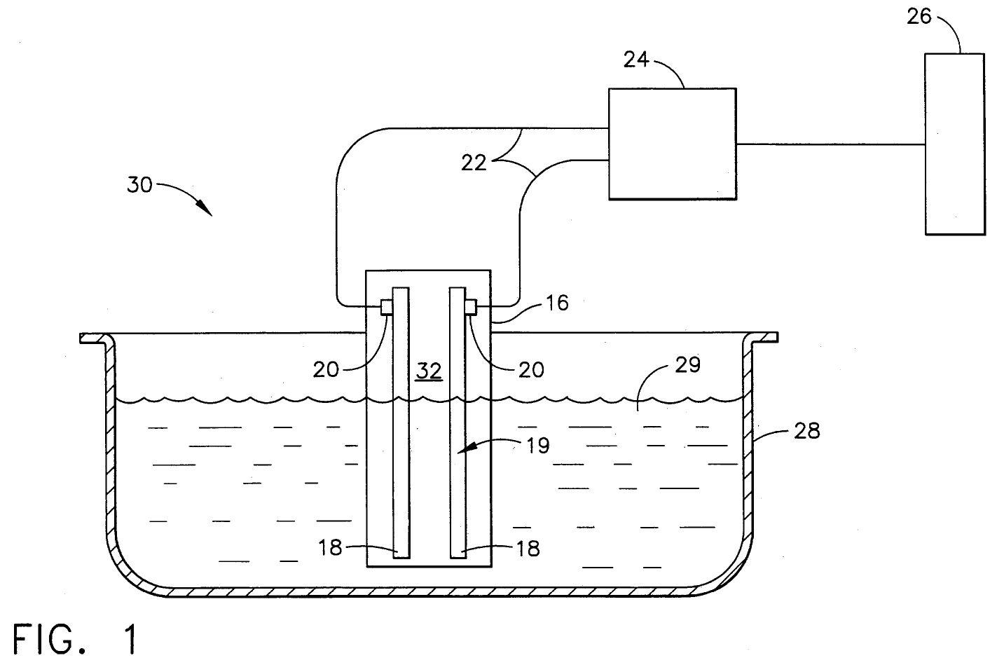

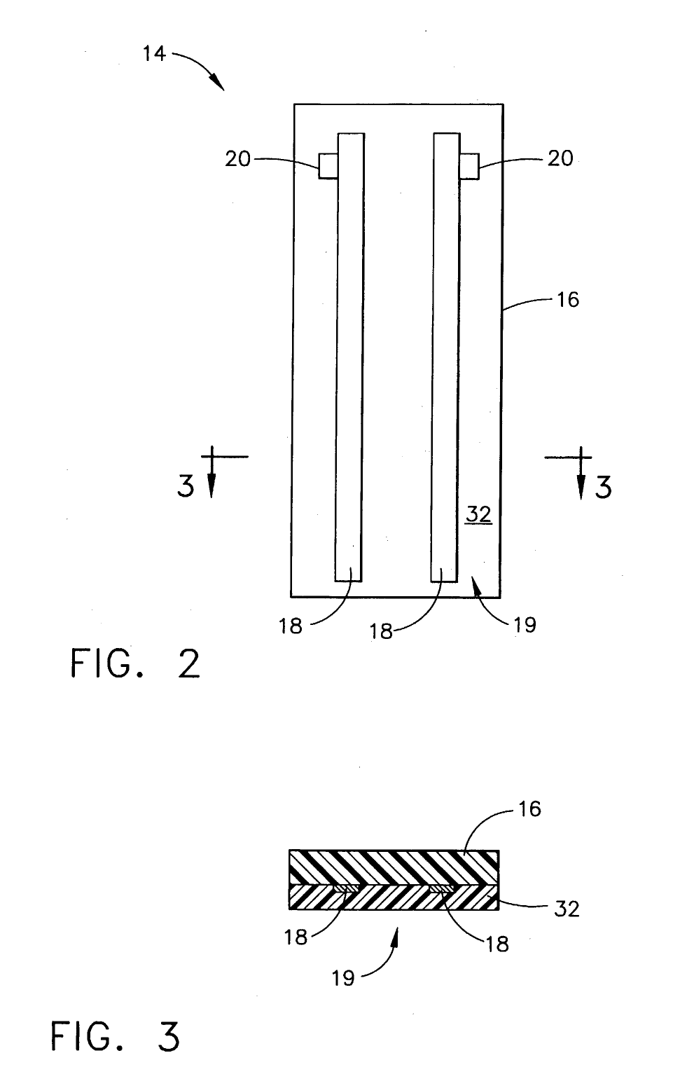

FIGS. 1-3 illustrate schematically a capacitive liquid level sensor 14 and its application in accordance with one embodiment of the invention. The liquid level sensor includes two parallel electrode strips 18 of an electrically conductive material that are supported along their respective lengths on surface 19 of an electrically insulated substrate 16. The conductive strips can be, for example, copper or gold, although any electrically conductive material may be used. The substrate can be, for example, conventional PC board material, fiberglass, polycarbonate, or the like. A coating 32 comprised of a porous material, as defined below, covers both electrode strips 18 as well as the exposed portion of surface 19. Porosity is defined as the ratio of the volume of the interstices of a material to the volume of its mass (or the void volume divided by the body volume). The term “porous” hereafter is used to describe a material with interconnected pores and a porosity of greater than about 1.0 cubic centimeter per gram. The term “porous material” hereafter is used to describe any material having such a porosity and having a resistance, as measured between the electrode strips, of greater than about 0.15 Ohm centimeters. The porous material may be an insulator or a semiconductor, such as, for example, a ceramic material such as aluminum oxide, manganese oxide, or the like, although other porous material can be used. Premair™ available from Engelhard Corp. of Iselin, N.J., and believed to include a manganese oxide composition, has proven to be efficacious in this application. The porous material can be applied, for example, by plasma spraying, flame spraying, dip coating, or similar process. The coating is clearly illustrated in the cross-sectional view in FIG. 3. A contact 20, suitable for attaching an electrical lead 22, is provided at one end of each of the electrode strips. The electrical leads provide for the connection of sensor 14 to a control unit 24. The control unit can be, for example, a computing device such as a microcontroller, a portion of the engine control module, or the like. The control unit serves to measure the capacitance between the two conductive electrode strips and from this measured capacitance calculates the actual liquid level. The control unit relays information, in the form of a signal corresponding to the liquid level, to a display unit 26 in the passenger cabin of the motor vehicle or to an appropriate controller on board the vehicle. Depending on the resistivity of the porous material, it may be advantageous to place a fixed capacitor (not illustrated) in series with the capacitive liquid level sensor to block a dc current that might otherwise flow through the sensor.

Again with reference to FIG. 1, in operation, liquid level sensor 14 is partially submerged in a liquid 29 contained in reservoir 28 so that the insulated substrate and the electrically conductive strips are perpendicular to the upper surface of the liquid. Liquid 29, the height of which is to be measured, is characterized by a dielectric constant K1, in contrast to the dielectric constant K2 of gas 30 above the surface of the liquid. Control unit 24 measures the capacitance between the two electrode strips and from this measurement is able to calculate the height of liquid 29. The total capacitance (Ctotal) of liquid level sensor 14, measured between the two electrode strips in accordance with the invention, is the sum of the capacitance (Cwet) of the fraction of the liquid level sensor that is submerged in liquid 29 plus the capacitance (Cdry) of the remainder of the liquid level sensor exposed to gas 30. Cwet and Cdry are, in turn, proportional to the length of strips 18 that is either submerged in liquid 29 or that is above the surface of the liquid, respectively, and to the dielectric constants K1 and K2, respectively. Control unit 24 is calibrated to work specifically with the two different fluids (fluid referring here to either liquid or gas) of known dielectric constants K1 and K2, so that control unit 24 is able to calculate from any measured capacitance the actual liquid level. After calculating the liquid level based on the measured Ctotal, control unit 24 relays a signal corresponding to the calculated liquid level to display unit 26 or to the on board controller. Thus, as the level of liquid 29 changes, control unit 24 continuously monitors the capacitance of liquid level sensor 14 and calculates the height of the liquid, relaying a signal corresponding to the liquid height information to display unit 26.

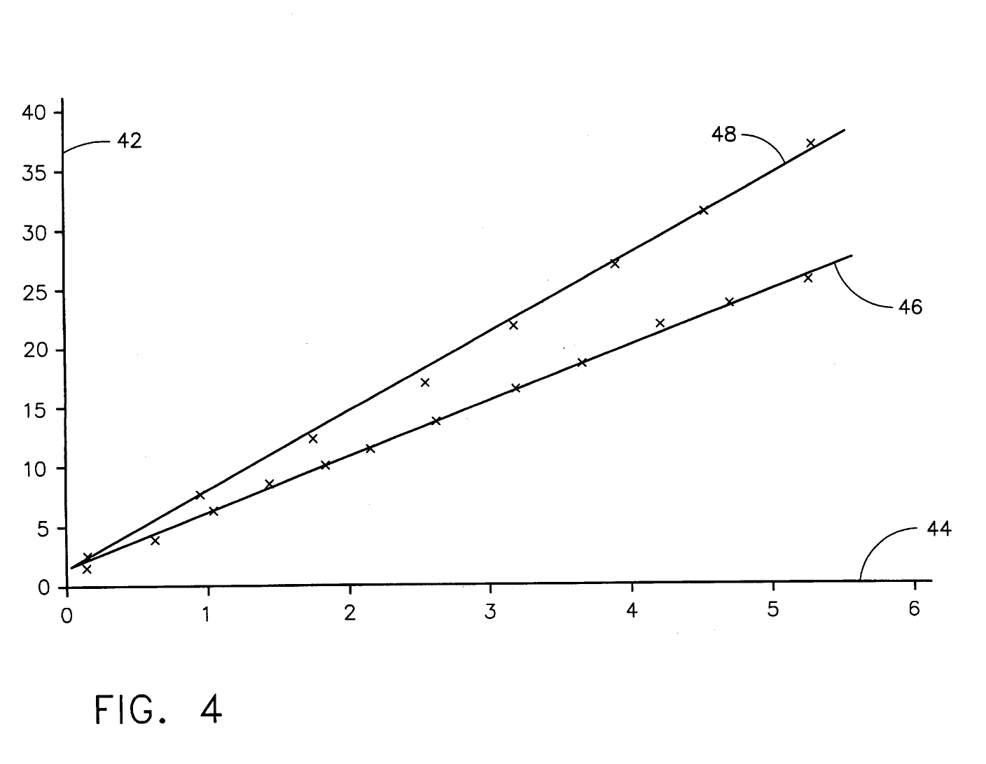

The following non-limiting examples illustrate liquid level measurement results obtained from the use of a capacitive liquid level sensor in accordance with an embodiment of the invention. In these particular exemplary embodiments of the invention, substrate 16 was fabricated from a strip of PC board FR4. Two parallel electrode strips 18 of copper were patterned on the substrate. The strips were ten centimeters in length and 0.3 millimeters in width. The two strips were separated by a constant gap of 0.5 millimeters. Coating 32 comprised of a porous material that covered the strips and the exposed portions of surface 19 was a low temperature catalytic coating known commercially as PremAir™. The coating was 25 microns thick. Electrical leads were bonded to contacts 20 and the sensor was connected through these leads to a B/K Precision model 875b capacitance meter. The resistance measured between the two electrodes was approximately 30 KOhms. The sensor was positioned with the strips vertically oriented in a container of fluid. The height of the liquid was varied, and the capacitance of the sensor was measured. In a first example, the container was filled with pure water, and in a second example the container was filled with windshield wiper solvent, the composition of which was primarily methanol and water. In both examples, the gas above the liquid was air at ambient conditions. The results obtained are shown graphically in FIG. 4, in which capacitance, measured in nanoFarads (nF), was plotted on vertical axis 42, and the height of the liquid, measured in centimeters (cm), was plotted on horizontal axis 44. Lower line 46 in FIG. 4 corresponds to data obtained when the liquid in reservoir 28 was water, and upper line 48 in FIG. 4 corresponds to data obtained when the liquid in reservoir 28 was windshield wiper solvent. In both cases a nearly linear dependence between liquid height and capacitance was obtained. A large and easily measurable change in capacitance was observed. This large measured capacitance avoids the necessity for expensive amplification or signal conditioning equipment in order to obtain a useful signal.

The control unit can be programmed in known manner to measure capacitance and to calculate and extract liquid level height from the measured capacitance when using a capacitive liquid level sensor in accordance with the invention. With a linear dependence between liquid level and measured capacitance, it is particularly straightforward to program the control unit.

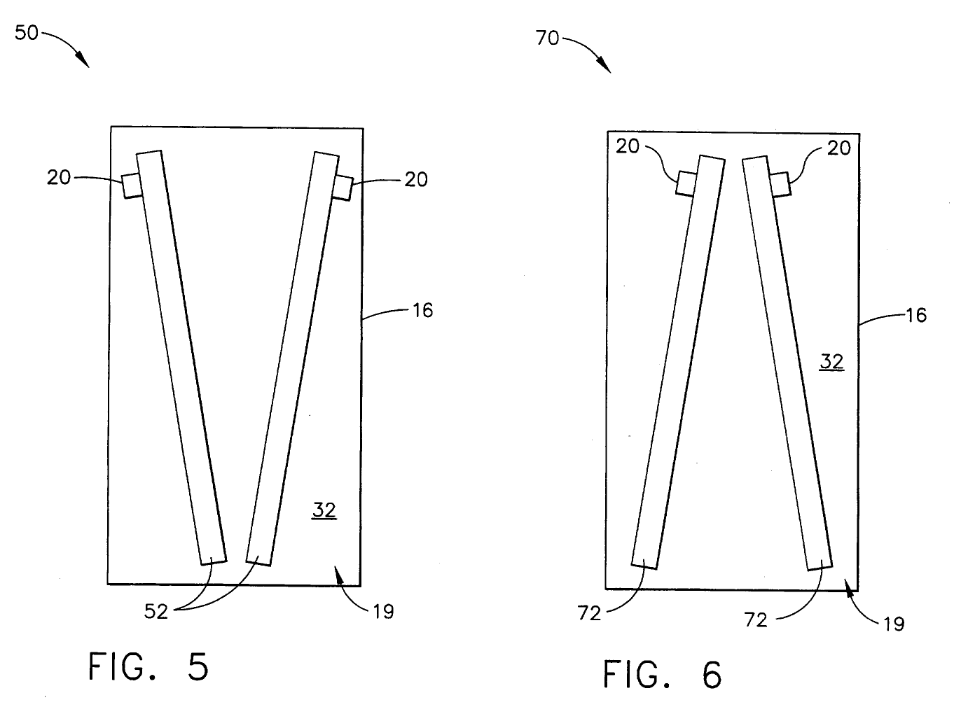

FIGS. 5 and 6 illustrate schematically, in plan view, two additional capacitive liquid level sensors 50 and 70, respectively, in accordance with further embodiments of the invention. Capacitive liquid level sensors 50 and 70 are constructed in similar manner to capacitive liquid level sensor 14 described above. Each sensor includes an insulated substrate 16 having a surface 19. Conductive electrodes are provided on surface 19 and include a contact 20 to which electrical leads (not pictured) can be attached. The conductive electrodes are coated with a porous material. In contrast to sensor 14, however, capacitive liquid level sensors 50 and 70 include conductive electrodes 52 and 72, respectively, which are not parallel. The spacing between electrodes 52 of capacitive liquid level sensor 50 increases from bottom to top so that the top ends of electrodes 52 are more widely spaced than are the bottom ends of those electrodes. In contrast, the spacing between electrodes 72 of capacitive liquid level sensor 70 decreases from bottom to top so that the bottom ends of electrodes 72 are more widely spaced than are the top ends of those electrodes. The varied spacing between the electrodes changes the sensitivity of the sensors as the liquid level changes. Because of the varied spacing between electrodes, sensor 50 has greater sensitivity when the reservoir containing the liquid being measured is nearly empty and sensor 70 has greater sensitivity when the reservoir is nearly full.

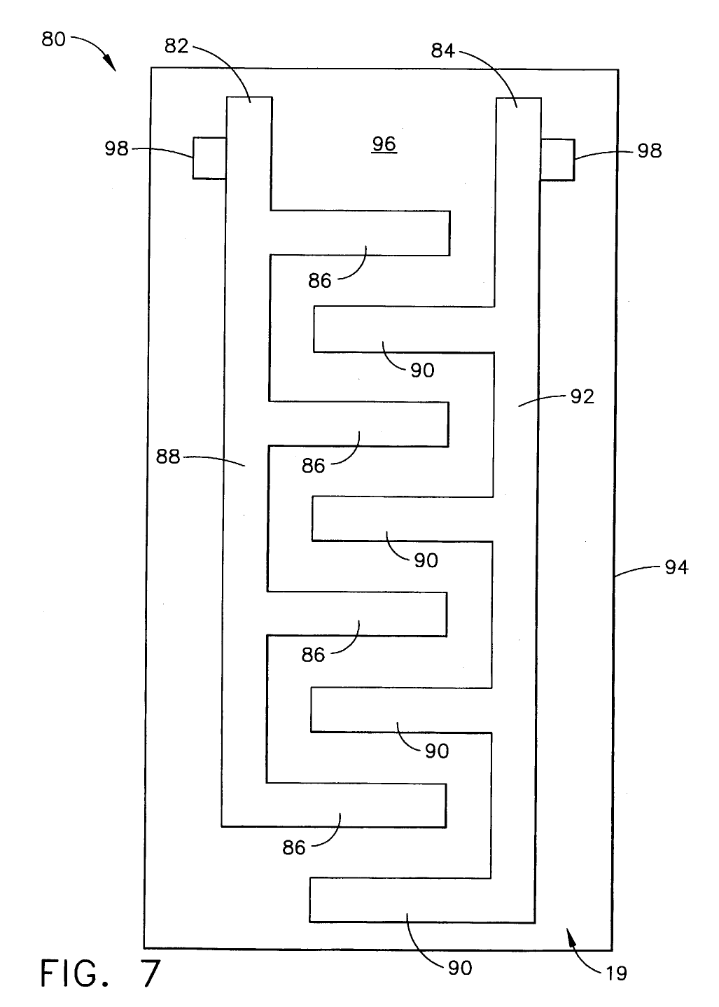

FIG. 7 schematically illustrates, in plan view, a capacitive liquid level sensor 80 in accordance with yet another embodiment of the invention. Sensor 80 includes a pair of conductive electrodes 82 and 84 each of which is comb shaped. Electrode 82 includes a plurality of electrode “teeth” 86 that are electrically coupled together by a bus electrode 88. Electrode 84 includes a plurality of electrode teeth 90 that are electrically coupled together by a bus electrode 92. The plurality of electrode teeth on electrodes 82 and 84 are interdigitated. Electrodes 82 and 84 are positioned on surface 19 of substrate 94 and are coated with a layer of porous material 96. A contact 98, suitable for attaching an electrical lead (not pictured) is provided at one end of each of the electrode strips. In use, sensor 80 is immersed in the liquid the height of which is to be measured with the two bus electrodes oriented perpendicular to the surface of the liquid. The sensitivity of sensor 80 is determined by the number, width and spacing of the electrode teeth.

In accordance with yet another embodiment of the invention, a capacitive liquid level sensor includes porous conductive or semiconductive electrodes supported on a non-porous substrate such a polymer substrate. The electrodes can be parallel, or non-parallel, or interdigitated in accordance with the embodiments described above. The porous conductive or semiconductive electrodes can be formed of materials such as porous manganese dioxide, porous polycrystalline silicon, or the like. In similar manner, the capacitive liquid level sensor can be formed as a parallel plate capacitor (not illustrated) with a first conductive electrode supported on an insulating substrate, a non-porous capacitor dielectric overlying the first conductive electrode, and a porous conductive electrode overlying the capacitor dielectric. Again, the porous conductive electrode can be any porous conductive material such as porous manganese dioxide, porous polycrystalline silicon, or the like.

Thus, it is apparent that there has been provided, in accordance with the invention, a capacitive liquid level sensor that meets the needs set forth above. This invention is kept inexpensive by the lack of complicated signal conditioning and amplification equipment, while at the same time being reliable due to its lack of moving parts. Although the invention has been described and illustrated with reference to specific embodiments thereof, it is not intended that the invention be limited to such illustrative embodiments. For example, the electrically conductive strips and the substrate may be made from materials other than those suggested above. The porous material covering the conductive strips may be any low-density, low-conductivity composition. The electrode strips may also be of a different geometry, length, and/or width than those provided in the illustrative embodiment and need not be straight, rectangular, parallel strips, although the use of such illustrated strips makes extraction of liquid level from measured capacitance particularly straightforward. Those of skill in the art will recognize that many variations and modifications of such embodiments are possible without departing from the spirit of the invention. Accordingly, it is intended to be included within the invention all such variations and modifications as fall within the scope of the appended claims.

1. A liquid level sensor comprising:
an insulated substrate;
a pair of spaced apart electrically conductive electrodes supported by the insulated substrate; and
a layer of porous material overlying the pair of spaced apart electrically conductive electrodes.

2. The sensor of claim 1 wherein the spaced apart electrically conductive electrodes comprise parallel metallic electrodes.

3. The sensor of claim 1 wherein the spaced apart electrically conductive electrodes comprise non-parallel conductive electrodes.

4. The sensor of claim 1 wherein the layer of porous material comprises a porous oxide material.

5. The sensor of claim 4 wherein layer of porous material comprises a material selected from the group consisting of manganese oxide and aluminum oxide.

6. The sensor of claim 1 wherein the layer of porous material comprises Premair™.

7. The sensor of claim 1 further comprising a contact to each of the pair of spaced apart electrically conductive electrodes, the contact configured for the attachment of an electrical lead.

8. A system for the measurement of liquid level in a motor vehicle, the system comprising:
a capacitive liquid level sensor immersed in a liquid the height of which is to be measured, the capacitive liquid level sensor comprising:
an electrically insulated substrate;
spaced apart electrically conductive electrodes supported by the electrically insulated substrate;
a porous material overlying the electrically conductive electrodes; and
a control unit electrically coupled to the electrically conductive electrodes.

9. The system of claim 8 wherein the control unit comprises a computing device configured to measure the capacitance between the electrically conductive electrodes.

10. The system of claim 9 wherein the control unit comprises a computing device configured to calculate the height of the liquid from the measured capacitance and to produce a signal corresponding to the calculated height.

11. The system of claim 10 further comprising a visual display device coupled to the control unit and configured to receive the signal and to produce a visual display responsive to the signal.

12. The system of claim 9 wherein the control unit comprises a computing device calibrated to measure capacitance between the electrically conductive electrodes immersed in a liquid characterized by a known dielectric constant.

13. The system of claim 8 wherein the spaced apart electrically conductive electrodes comprise copper leads and the porous material comprises a porous oxide material.

14. The system of claim 13 wherein the porous material comprises a material selected from the group consisting of manganese oxide and aluminum oxide.

15. A capacitive liquid level sensor comprising:
an electrically insulated substrate configured for orientation within and perpendicular to the surface of a liquid the height of which is to be measured;
two spaced-apart, rectangular, parallel metallic strips supported by the substrate, each of the strips configured with an electrical contact near an end thereof; and
a porous material overlying the metallic strips and portions of the insulated support member not covered by the metallic strips.

16. The sensor of claim 15 wherein the porous material comprises a material selected from the group consisting of manganese oxide and aluminum oxide.

17. A liquid level sensor comprising:
an insulated substrate;
a pair of spaced-apart electrodes supported by the insulated substrate, the spaced-apart electrodes comprising a porous conductive material; and
a contact area on each of the pair of spaced-apart, electrically conductive electrodes configured for the attachment thereto of an electrical lead.

18. A capacitive liquid level sensor comprising:
an insulated substrate;
a pair of spaced-apart comb-shaped conductive electrodes having interdigitated electrode teeth supported on the insulated substrate; and
a layer of porous material overlying the pair of spaced-apart comb-shaped electrodes.

19. A capacitive liquid level sensor comprising:
an insulated substrate;
a first electrically conductive electrode supported on the insulated substrate;
a non-porous capacitor dielectric overlying the first electrically conductive electrode; and
a porous conductive second electrode overlying the non-porous capacitor dielectric.
